(19) United States
(12) Patent Application Publication
(10) Pub. No.: US 2008/0042498 A1
(43) Pub. Date: Feb. 21, 2008

(54) Method for manufacturing an electric machine and electric machine manufactured according to said method

(76) Inventor: Alexander Beer, Regensburg (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/819,503

(22) Filed: Jun. 27, 2007

(30) Foreign Application Priority Data
Jun. 27, 2006 (DE) 10 2006 029803.9

(51) Int. Cl. H02K 15/02; H02K 1/04; H02K 15/12

(52) U.S. Cl. 310/42; 29/596; 29/598; 310/43

(57) ABSTRACT

A method for manufacturing a machine element of an electric machine, with a plurality of magnetic poles distributed around a machine axis and with at least one coil, having several conductors distributed around the machine axis and each of which is located in a groove, wherein the machine element forms a gap surface enclosing the machine axis, on which (gap surface) when the machine is mounted it adjoins a second machine element via a machine gap and is made of a plastic, and wherein at least in the recesses for the conductors, channel sections are formed through which a coolant can circulate.

### BACKGROUND OF THE INVENTION

The invention relates to a method for manufacturing a machine element of an electric machine with a plurality of magnetic poles distributed around a machine axis and with at least one coil.

To increase the performance of an electric or electrodynamic machine, the method is known in the art of providing a so-called can on the inner surface, facing the rotor, of a stator enclosing the rotor or on the inner surface of the stator plate packet, i.e. a cylindrical wall section which seals the grooves formed in the plate packet that are open toward the rotor for accommodating the sections or conductors of the stator coil, to the machine gap between the stator and rotor. The part of each groove not occupied by the electrical conductors of the coil can then be used as a channel of a cooling channel system, through which a suitable, electrically non-conductive coolant (DE 10 2004 013 721.8) circulates.

A disadvantage of this method is that the can, i.e. the wall section or can closing the machine element on its gap surface in the area of the grooves is connected insufficiently with the inner surface of the plate packet enclosing the rotor, thus resulting after a short period of operation in loosening of the can from the plate packet and subsequent damage to the can by the rotating rotor, so that the cooling channel system in the end is no longer sealed. There are also problems with respect to the sealing of the cooling channel system to other elements of the stator or of the stator housing.

It is an object of the invention is to present a method that prevents these disadvantages.

### SUMMARY OF THE INVENTION

The electric machine according to the invention is, for example, a motor, e.g. a synchronous motor, an asynchronous motor or a direct current motor. Preferably the machine according to the invention is such a machine with a stator comprising the coil and with a rotor enclosed by the stator or with a rotor enclosing the stator.

In the machine according to the invention, the machine element comprising the coil, at least on its surface adjoining the machine gap, is made of an electrically insulating material, namely of plastic, according to a first embodiment of the invention using a tube-shaped wall section (can), which extends with strip-shaped protrusions in grooves for accommodating the conductors of the coil and is held positively there, so that the danger of loosening of this wall section from the machine element body or plate packet comprising the grooves does not exist.

According to a further general embodiment of the invention, the machine element body comprising the coil and forming the magnetic poles is made of plastic, which has a high content of electrically non-conductive, although magnetically conductive fillers.

The electric machine according to the invention fulfills all requirements placed on such a machine, namely high mechanical strength, in particular also vibration strength and impact strength, complete electric insulation from the surrounding area, complete electric insulation of the machine mounts, complete electric insulation of the drive shaft, explosion protection for operation in environments with hazardous substances, increased and significantly improved cooling and heat dissipation for higher power density, integration of the power and control electronics in the housing of the machine.

The machine according to the invention is controlled preferably by high-speed switching IGBTs. The further machine element engaging with the magnetic poles of the coil, i.e. preferably the rotor, is preferably equipped with permanent magnets, so as to achieve a high power density with a simplified design.

### BRIEF DESCRIPTION OF THE INVENTION

The invention is described in more detail below based on exemplary embodiments with reference to the drawings, wherein:

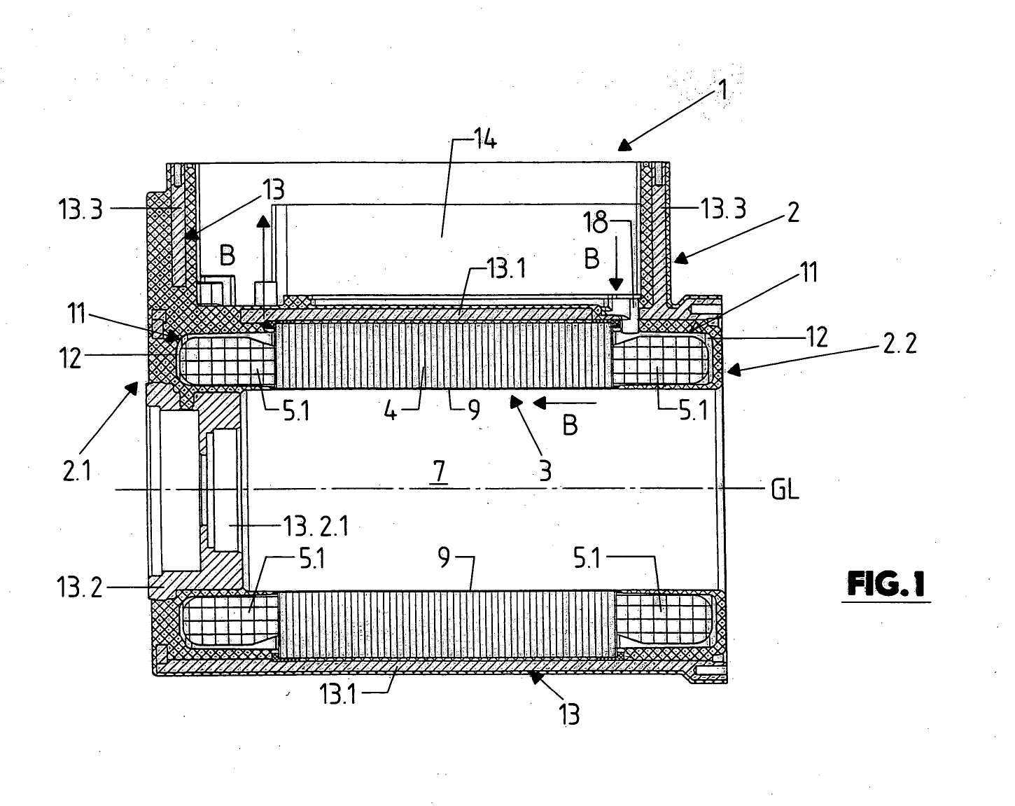

FIG. 1 shows a simplified view of a longitudinal cross section through a motor housing and the stator of an electric motor;

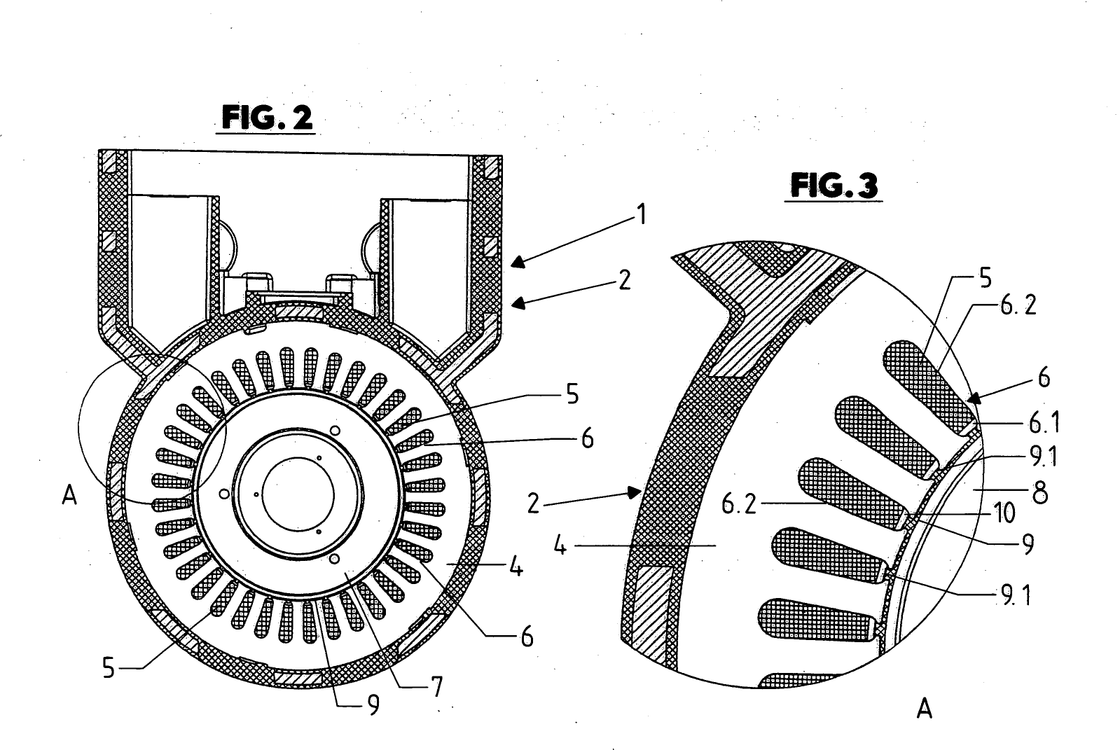

FIG. 2 shows a simplified view of a cross section through the housing and the sector of FIG. 1;

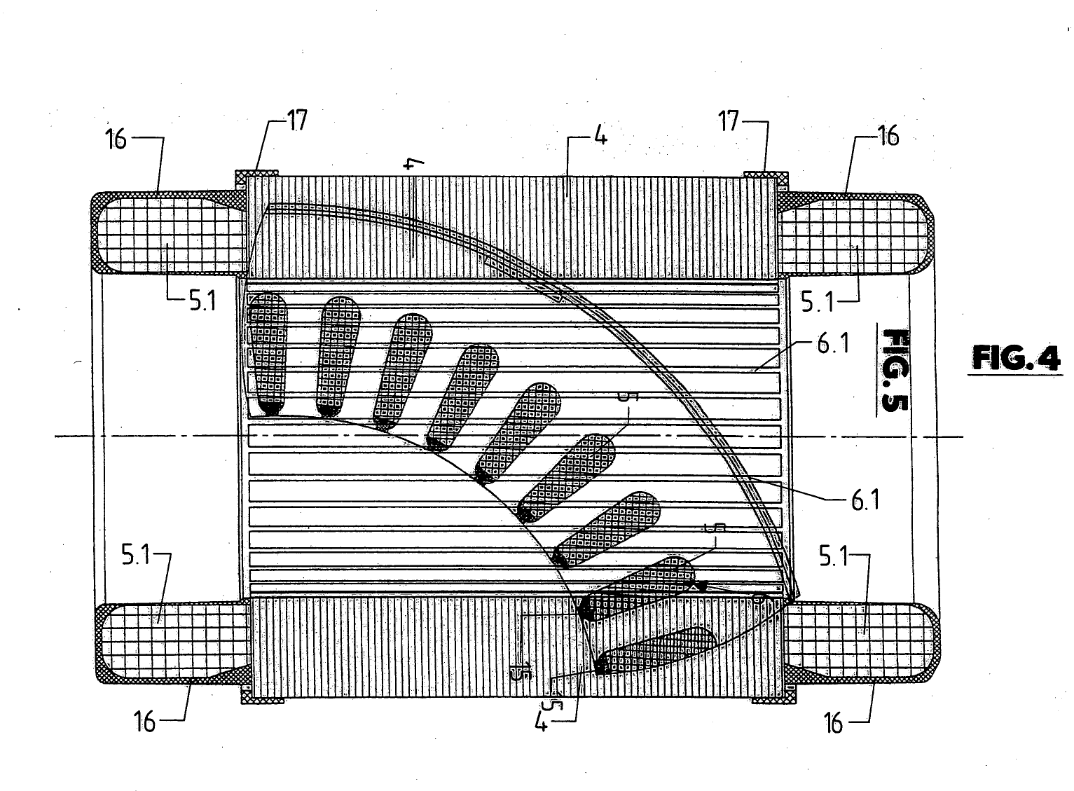

FIG. 3 shows an enlarged detail view of the area A of FIG. 2;

FIG. 4 shows a longitudinal cross section of the stator of the electric motor of FIGS. 1-3 in a prepared condition for the manufacture by casting of said housing and of a can;

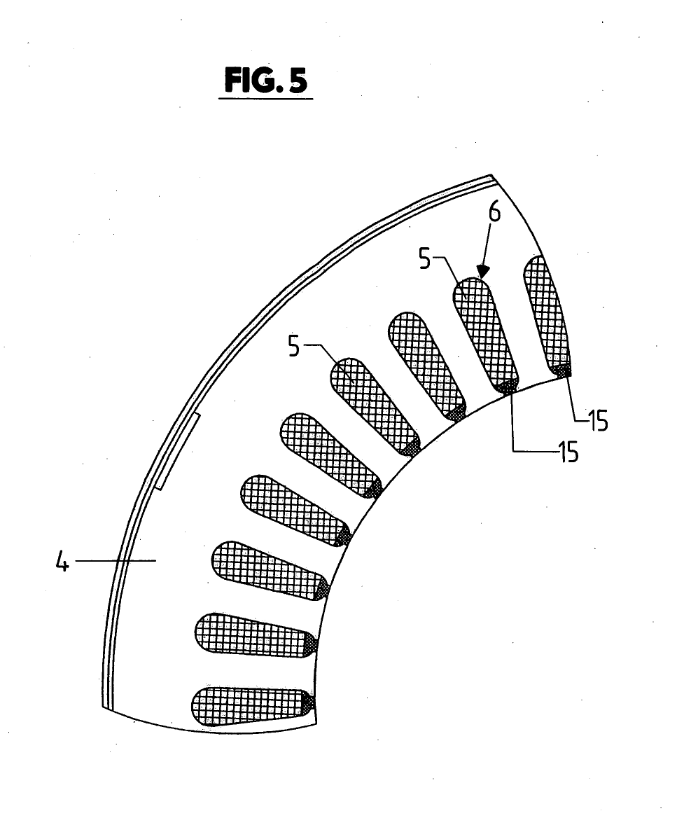

FIG. 5 shows an enlarged partial view of a cross section through a part of the coil and of the plate packet of the stator of FIG. 4;

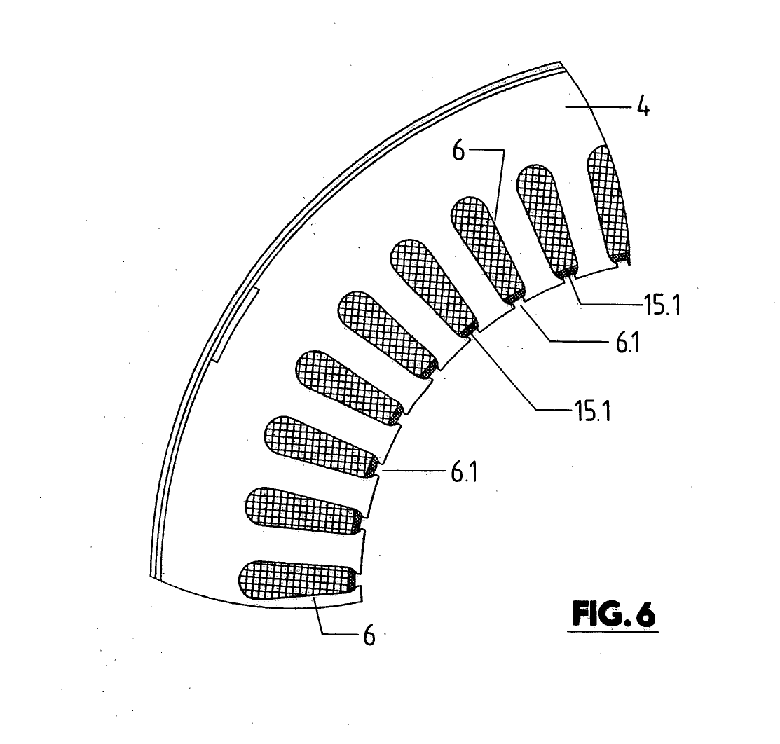

FIG. 6 shows a view similar to FIG. 5, however after a further processing step;

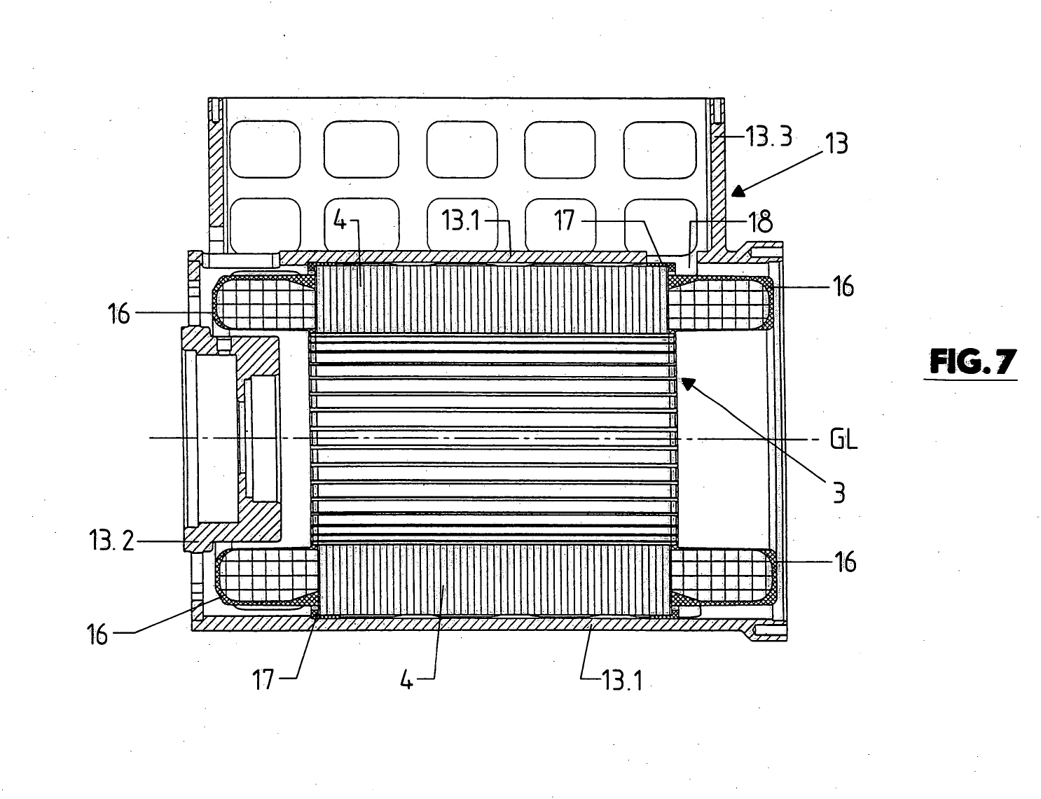

FIG. 7 shows the stator mounted on a metal frame of the motor housing with the aid of centering rings;

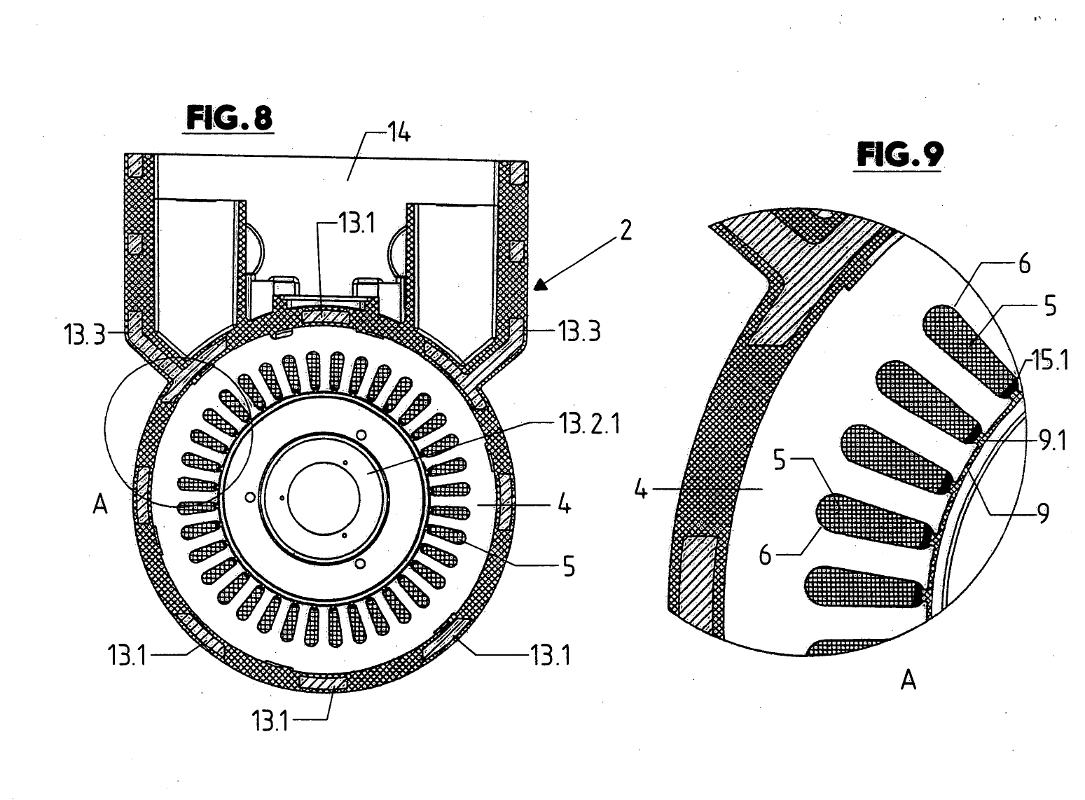

FIG. 8 shows a cross section similar to FIG. 2, after casting of the motor housing and of the can;

FIG. 9 shows an enlarged detail view of the area A of FIG. 8; and

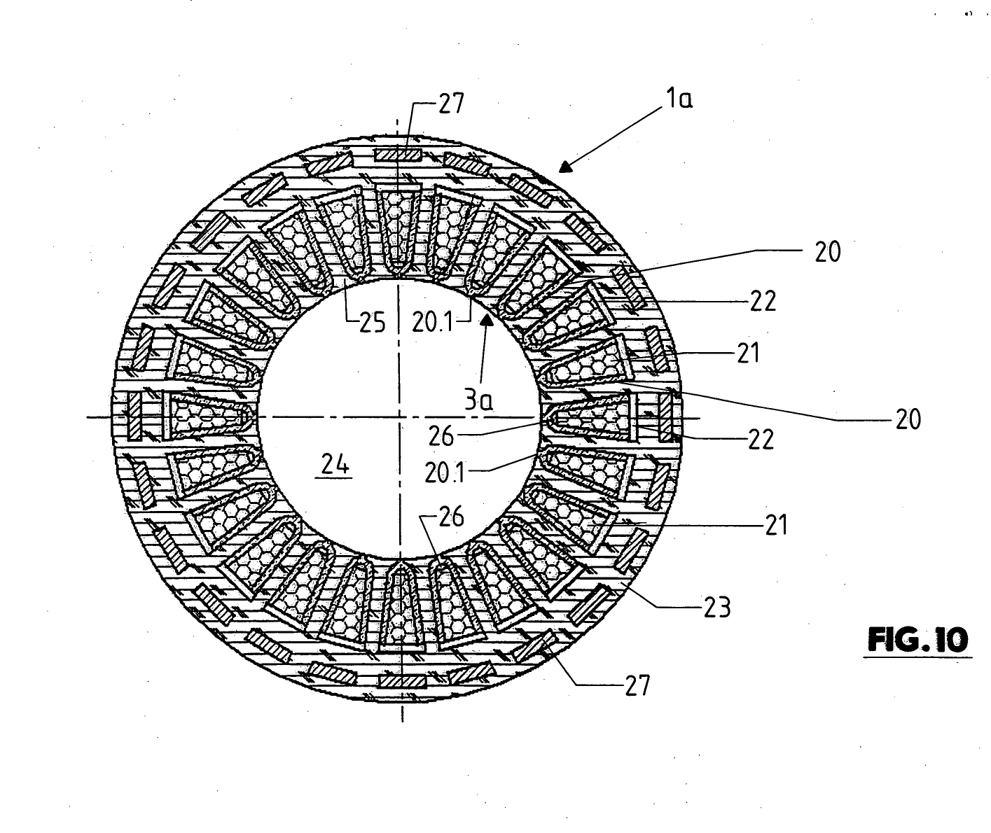

FIG. 10 shows a cross section through the stator of an electric motor according to a further embodiment of the invention.

### DETAILED DESCRIPTION OF THE INVENTION

The high-power electric motor generally designated 1 in FIGS. 1-9 has an external motor housing 2 and of the stator 3 located concentrically around a housing longitudinal axis GL. The stator 3 is formed essentially by a plate packet 4 (bundle of laminations or armature) and a coil 5, the conductors or coil sections of which occupy grooves 6 that are open toward the axis GL and extend parallel to said axis. The grooves 6 are designed so that they are open toward the space 7 enclosed by the stator 3 and serving to accommodate the rotor 8 through a slot 6.1 extending over the entire length of the plate packet 4 parallel to the axis GL, which (slot) has a considerably reduced width as compared to the remaining area 6.2 of each groove 6. The coil 5 forms coil ends 5.1 on both ends of the plate packet 4 and protruding past said ends.

The inner surface of the plate packet 4 facing the space 7 or the gap between the plate packet 4 and a second machine element, the rotor 8 is enclosed by a tube-shaped wall section 9 (can), which also seals all grooves 6 on its slot 6.1 toward the space 7 or the rotor 8. On both ends, the wall section 9 merges into an end 2.1 or 2.2 of the motor housing 2, forming a seal.

As shown in FIGS. 1-3, the cylindrical wall section 9 is formed so that it extends with strip-shaped sections 9.1 protruding radially over the outer surface of said wall section 9 through the slots 6.1 into the grooves 6, so that the strip-shaped sections 9.1 positively engage behind the plate packet 4 in the area of the grooves 6 or their slots 6.1. The strip-shaped protrusions 9.1 are designed, however, so that in each groove 6 between the protrusion 9.1 there and the coil 5, a gap or channel section 10 remains, which extends over the entire length of the plate packet 4 parallel to the axis GL and ends in an outwardly closed ring space 11 enclosing the axis GL. On both housing ends 2.1 and 2.2 such a ring space 11 is formed in which the coil ends 5.1 there are accommodated. The ring spaces 11 are designed somewhat larger than the coil ends 5.1, so that in each ring space 11 around the coil ends 5.1 a gap or channel section 12 is formed, which then is connected with all channel sections 10. This design makes it possible to effectively cool the stator 3 or its coil 5 including the coil end 5.1 during operation of the electric motor 1 with a suitable, electrically non-conductive coolant, preferably a liquid coolant (e.g. transformer oil or cold switch oil), which for this purpose flows through the cooling channel structure formed by the channel sections 10 and 12, corresponding to the arrows B of FIG. 1, for example from the ring space or channel section 12 formed in the housing end 2.2 via the channel sections 10 to the ring space 11 or channel section 12 formed in the housing end 2.2. The coolant thus thoroughly circulates through the coil ends 5.1 and the sections of the coil 5 in the grooves 6, and the coolant also circulates through the intermediate spaces between the conductors in the grooves 6.

The cooling channel structure formed by the channel sections 10 and 12 is part of a cooling circuit, which comprises a reservoir outside the motor and a circulating pump for the liquid coolant, in addition to an external heat exchanger. Due to the wall section 9 the cooling channel structure formed by the channel sections 10 and 12 is sealed toward the space 7 accommodating the rotor 8. Due to the anchoring of the wall section 9 with a plurality of strip-shaped protrusions 9.1 each engaging in a groove 6, the wall section 9 (can) is reliably anchored on the inner surface of the plate packet 4. Despite a relatively small gap width between the rotor 8 and the plate packet 4 for the desired high efficiency of the rotor 1 and a resulting low wall thickness of the wall section 9, radially inward deformation of the wall section 9 due to the pressure of the coolant is effectively prevented.

The motor housing 2 in the depicted embodiment is made essentially of plastic and is manufactured for example as one piece with the wall section 9 in the manner described in more detail below. In order to achieve the required strength, the housing 2 contains a metal frame 13, which has a filigree or multiply interrupted design, namely with a cylindrical section 13.1 enclosing the stator 3, with a section 13.3 reinforcing the housing end 2.1, which (section) also is designed as a bearing bore for accommodating a bearing for the shaft of the rotor 8, and with an upper section 13.3, which reinforces a housing section 2.3 than can be closed with a cover not depicted. This housing section forms an inner spacer 14 for accommodating the electric components, switching circuits, etc. needed for operation of the motor 1.

On the element forming the housing end 2.2 the metal frame 13 is designed for bolting on a cover not depicted, in which then the rotor 8 and its shaft are also mounted on bearings. Toward the outside, the metal frame 13 is essentially enclosed by the plastic material of the housing 2.

FIGS. 4-9 illustrate the manufacture of the electric motor 1. First, corresponding to FIGS. 4 and 5, the stator 3 is manufactured with the coil 5 and the coil ends 5.1. In this process, using a suitable mold, the space of the grooves 6 not occupied by the conductors of the coil 5, i.e. the respective later channel section 12, and the part of the respective ring space 11 not occupied by the coil ends 5.1, i.e. the respective later channel section 12, is filled with a filler that can be removed by heating, for example wax, as indicated in FIGS. 4 and 5 by 15 (for the grooves 6) and 16 (for the coil ends 5.1).

The wax filling 15 in each groove 6 is then partially removed in the following processing step, so that the slots 6.1 with their undercut formed by the adjacent enlargement of each groove 6 are exposed, as depicted in FIG. 6. In each groove 6, therefore, a wax filling 15.1 remains, corresponding to the channel section 10 forming said groove and keeping it free and also outwardly sealing the space of each groove occupied by the conductors of the coil 5.

The partial removal of the wax filling 15 is achieved for example by mechanical means using a suitable tool, e.g. a multiple tool, which is used for the simultaneous partial removal of the wax filling 15 from all grooves 6 or a large number of multiple grooves and for creating the remaining wax filling 15.1. The stator 3 thus provided with wax fillings 15.1 and 16 is then inserted with the centering rings 17 made of plastic into the metal frame, so that after insertion the stator 3 is centered, i.e. its longitudinal axis is on the same axis as the axis GL or the axis of the bearing bore 13.2.1 prepared in the metal frame. Afterwards, the metal frame 13 is inserted with the stator 3 in a multi-part casting mold, in which the housing 2 and simultaneously the wall section 9 are created by sheathing the metal frame 13 with plastic or synthetic resin. Due to the partial removal of the wax filling 15 in the grooves 16, during casting of the housing 2 together with the wall section 9, the positively anchoring groove-shaped protrusions 9.1 can also be formed on the inner surface of the plate packet 4.

Of course, the casting mold used can have a core, which keeps the inner space 7 and also the bearing bore 13.2.1 prepared in the metal frame 13 free during casting of the housing 2. Due to the centering rings 17, the plate packet 4 is at a distance from the inner surface of the section 13.1 on the length extending between said centering rings, so that this ring space is also filled by the plastic during casting of the housing 2, and the stator 3 is mechanically bonded solidly with the metal frame 13, but fully electrically insulated.

The plastic used is preferably a synthetic resin, for example a duroplastic synthetic resin or a dual-component synthetic resin, which hardens for example at a temperature that is significantly below the melting temperature of the material used for the wax fillings.

After hardening of plastic forming the housing 2 and the wall section 9 (can), the housing 2 with the stator 3 is heated in a suitable manner, for example in a furnace, to a temperature that is significantly above the melting temperature of the wax used for the wax fillings 15.1 and 16. At this temperature the liquefied wax is removed, namely via inlets 18 likewise formed from the wax at the spaces 11 occupied by the coil ends 5.1. At the same time, the heating achieves additional hardening of the plastic, so that said material and the housing 2 are stable also at higher operating temperatures of the motor 1.

After removal of the wax fillings 15.1 and 16, the cooling channel structure through which the preferably liquid coolant can flow is completed. In further assembly steps the rotor 8, preferably equipped with permanent magnets, is assembled together with the corresponding bearings and the cover closing the housing 2 on the housing side 2.2.

The stator 3, namely the plate packet 4 and the coil 5 including the coil ends 5.1, are electrically insulated from electrically conductive parts of the housing 2, namely from the metal frame 13 and the bearings or bearing bores formed by said frame and, by the wall section 9 (can), also from the rotor 8.

The cooling channels through which the coolant flows are designed so that in the area of the respective channel section 12 the coolant also completely circulates around the coil ends 5.1 and also the heat energy produced here can be absorbed by the coolant.

As indicated in FIG. 1, the inner space 17 of the upper housing section 2.3 is connected via the opening 18 with the cooling channel structure formed by the channel sections 10 and 12, i.e. also the power electronics in the inner space 17 are cooled by the cooling medium.

The embodiment described above features further advantages, namely for example:

The grooves 6 are designed as cooling channels, so that direct heat dissipation via the coolant takes place in the coil space of the stator 3;

The wall section 9 (can) is reliably held to the inner surface of the plate packet 4 by the sections 9.1 positively engaging the undercuts on the slots 6.1;

Also at a higher pressure of the coolant circulating through the cooling channels of the stator 3, there is no danger of loosening of the wall section 9 from the plate packet;

Location of the power electronics in the coolant circuit for direct heat dissipation of the waste heat from the power electronics;

Electrical insulation of the entire stator 3, including the plate packet 4 and coil 5, from the metal frame 13 and the elements made of metal materials fastened to or formed on said frame;

Housing 2 made of plastic;

Embedded metal frame 13 for high strength and stability of the motor.

Further advantages include the simplified manufacture of the housing 2 including the wall section 9 and of the various channels of the cooling channel structure within the stator 3 due to a simplified plastic casting process with subsequent removal by melting of the wax fillings 15.1 and 16. The strip-shaped protrusions 9.1 engaging in the grooves 6 achieve an extremely stable bond of the wall section 9 to the inner surface of the plate packet 4 through positive locking so that the wall section 9, when designed with a thin wall, is anchored reliably, in particular also for high loads, on the inner surface of the plate packet 4, especially also in the event of high dynamic loads of the motor 1, e.g. when used in motor vehicles and at high pressures of the liquid coolant.

Manufacturing the housing 2 using the plastic casting process enables its manufacture in the form depicted in FIG. 1 as one piece, thus eliminating complex sealing and joining processes. Furthermore, finishing operations are eliminated due to the high manufacturing precision of the casting process. The metal wire frame 13 achieves high mechanical strength and high dimensional stability. All current-carrying components, especially high-voltage components of the power electronics, are located in the housing 2 or in the housing section 2.3 there that can be closed by a cover, resulting in short electrical connections between these components and the coil 5. Furthermore, all components are cooled by exposure to the coolant. Since especially also the inner surfaces of the inner space 14 are made of the plastic, the entire power electronics located in this inner space, including the capacitive and inductive components, are electrically insulated in the housing 2. Due to corresponding shaping of the wax fillings, an optimal contour for the areas of the cooling channel structure exposed to the coolant can be achieved, namely for the effective transfer of heat from the coil 5 to the coolant. The shape and/or position of the channels through which the coolant circulates can have a wide variety of designs.

It was assumed above that the wax fillings 15 are processed mechanically to create the reduced wax fillings 15.1. Other methods are also conceivable, for example in the manner that the wax fillings 15.1 are created instead of the wax fillings 15, namely using a multiple mold tool, which comprises at least one axially movable tool element for removal from the mold.

FIG. 10 shows as a further embodiment of the invention a cross section through the stator 3a of a motor la. The stator 3a in this embodiment does not comprise a plate packet made of a ferromagnetic material for forming the poles, but instead is made of a plastic, which contains an electrically conductive, but magnetically conductive filler, for example in the form of an oxide of a ferromagnetic material.

In particular, the stator 3a consists of a plurality of coil carriers 20, which are manufactured from an electrically and magnetically non-conductive material, for example plastic, and located at regular angle distances and at the same radial distance around the longitudinal axis of the stator 3a oriented perpendicular to the drawing plane of FIG. 1. Each coil carrier 20 has an essentially V-shaped design, namely with a rib-shaped elongation 20.1 on the rounded, closed side facing the axis of the stator 3a. The plane of symmetry, to which each coil carrier 20 including its rib-shaped elongation 20.1 is mirrored symmetrically, is oriented radially to the stator axis. The sections or conductors of the coil 21 are located in the coil carriers 20. The radially outward open side of each coil carrier 20 is closed by a strip-shaped cover 22, which, just as the coil carrier 20, extends over the entire length of the stator 3a. Preferably the coil carriers 20 are connected with each other to form a ring-shaped array, e.g. by ribs not depicted.

In the manufacture of the stator 3a, first the conductors of the coil 21 are inserted into the coil carriers 20 arranged in a ring-shaped circle around the axis of the stator 3a, radially from outside, so that the entire coil 21 can be manufactured especially easily in an outer winding process. This makes it possible in particular to create the entire coil 21 automatically and mechanically. Afterwards, the sections of the coil 21 in each coil carrier 20 are filled with wax, so that the wax fills the hollow spaces formed during insertion of the conductors, in particular also on the radially inward, closed area of each coil carrier 20. The coil carriers 20 are then sealed tightly with the corresponding strip-shaped cover 22. Afterwards, in a corresponding mold, the stator body 23 is molded from the plastic with the electrically insulating but magnetically conducting filler in the manner that the individual coil carriers 20 are embedded in the stator body 23 and extend with the free ends of their ribs 20.1 to the inner surface of the stator 3a enclosing the opening 24 for the rotor not depicted, and thus forming the magnetic gap between two respective adjacent poles. For mechanical reinforcement of the stator 3a, a metal frame 26 is embedded in said stator, radially offset outward in relation to the coil carrier 20.

To simplify the molding of the stator body 23 while keeping the space 24 free for the rotor, it can be effective to form the coil carrier array comprising the individual coil carriers 20 so that the ribs 20.1 protruding from the V-shaped sections of the coil carriers 20 each merge into a common cylindrical wall section 25 enclosing the space 24, which (wall section) likewise is made of plastic, preferably manufactured as one piece with the coil carriers 20, and from the peripheral surface of which the coil carriers 20 protrude radially.

After molding the stator body 23 the wax is likewise removed by heating, so that the channels 26 are formed in each coil carrier 20 between the conductors there of the coil 21 and also on the radially inward closed area, through which (channels) a preferably liquid, electrically insulating coolant, e.g. transformer oil, circulates during operation of the motor la for cooling the coil 21 and therefore the stator 3a.

While the electric motor 1 is suitable and intended especially for high performance, the electric motor la is an especially economical solution for a motor with low power.

The invention was described above based on exemplary embodiments. It goes without saying that numerous variations and modifications are possible without abandoning the underlying inventive idea upon which the invention is based.

For example, it is possible to manufacture the cover 22 also from wax, so that after removal of the wax by melting, the space previously occupied by the respective cover 22 likewise forms a channel, through which the coolant circulates.

Reference list

| | |
|---|---|
| 1, 1a | electric motor |
| 2 | rotor or stator housing |
| 2.1, 2.2 | housing side |
| 2.3 | housing section |
| 3, 3a | stator |
| 4 | plate packet |
| 5 | coil |
| 5.1 | coil end |
| 6 | coil groove |
| 6.1 | slot |
| 6.2 | inner groove area |
| 7 | rotor space |
| 8 | rotor |
| 9 | wall section or can |
| 9.1 | rib-shaped section |
| 10 | gap-shaped section of flow channel |
| 11 | space |
| 12 | gap-shaped section of flow channel |
| 13 | metal frame |
| 13.1, 13.2, 13.3 | section of metal frame |
| 13, 13.2.1 | bearing bore |
| 14 | inner space of housing section 2.3 |
| 15, 16 | wax filling |
| 15.1 | reduced wax filling |
| 17 | centering ring made of plastic |
| 18 | opening |
| 20 | coil holder |
| 20.1 | rib-shaped elongation of coil holder 20 |
| 21 | coil |
| 22 | cover |
| 23 | stator body |
| 24 | inner space for rotor |
| 25 | hollow cylindrical wall section |
| 26 | metal frame |
| A | detail |
| B | flow directions of liquid coolant through the |
| | cooling channel structure of the stator 3 |
| GL | housing axis |

What is claimed is:

1. A method for manufacturing a machine element of an electric machine having a plurality of magnetic poles distributed around a machine axis (GL) and with at least one coil, comprising several conductors distributed around the machine axis (GL) and each of which is located in a hollow space or in a groove, in which the machine element forms a gap surface enclosing the machine axis (GL), on which the gap surface when the machine is mounted the machine element adjoins a second machine element via a machine gap and is made of a plastic, and wherein at least in the hollow space or in the groove for the several conductors, channel sections are formed through which a coolant can circulate, characterized in that the machine element is manufactured at least on its gap surface from plastic in a molding or casting process, and that the channel sections are created using a filling material, which is inserted and/or applied before the molding or casting process to keep the channel sections free and is removed after the molding or casting process.

2. The method according to claim 1, wherein the filling material is removed by heating and or melting.

3. The method according to claim 1, wherein the machine element has several grooves that are open in a direction of the machine gap for coil sections of the at least one coil, the several grooves are provided with the filling material after insertion of the at least one coil so that this material forms a filling covering a respective coil section in the inside of each groove, but freeing a respective groove in the area of a slot-shaped opening, and that in the molding or casting process a tube-shaped wall enclosing the machine element on its surface facing the machine gap is created from the plastic, with strip-shaped protrusions extending into the several grooves and positively anchored there.

4. The method according to claim 3, wherein each groove is completely filled with the filling material in a section not occupied by the coil and adjoining the slot-shaped opening of the groove, and that in a further processing step the filling material is removed again with the exception of the filling covering the respective section of the coil, but freeing the groove in the area of the slot-shaped opening.

5. The method according to claim 3, wherein the several grooves have a reduced groove width at the slot-shaped opening and an enlarged groove width at a distance from the slot-shaped opening.

6. The method according to claim 5, wherein the filling made of the filling material is inserted so that the slot-shaped opening is kept free in an area with an enlarged width adjoining said opening.

7. The method according to claim 1, wherein the use of a machine element body in the form of a plate packet comprising the grooves for the sections of the coil.

8. The method according to claim 1, wherein the at least one coil comprises at least one coil end and that in the area of at least one coil end, at least one cooling medium channel enclosing the latter at least partially is formed by the fact that the at least one coil end are enclosed at least partially by the filling material, that afterwards a section of the machine element enclosing the at least one coil end is created from plastic and then the filling material is removed to expose the cooling medium channel.

9. The method according to claim 8, wherein the section of the machine element enclosing the at least one coil end is created in a joint processing step and as one piece with the machine element on a wall section covering its gap surface.

10. The method according to claim 3, wherein sections of the at least one coil are located in a coil carrier made of a magnetically neutral material, that the coil carrier distributed around the machine axis on the gap surface are filled with the filling material after insertion of the at least one coil, that afterwards the coil carrier is embedded in a plastic, which contains an electrically insulating, but magnetically conductive filler, thus producing a machine element body made of plastic and forming the plurality of magnetic poles on the gap surface.

11. The method according to claim 1, wherein the molding or casting process, a reinforcing metal frame forming functional elements of the machine element, is embedded in the plastic.

12. The method according to claim 11, wherein the molding process is conducted in the manner that the metal frame is enclosed at least to the greatest extent possible by the plastic.

13. The method according to claim 11, wherein the molding process is conducted so that the at least one coil and a part of the machine element possibly made of a magnetically and electrically conductive material and accommodating the coil, a plate packet, is electrically insulated from the metal frame.

14. The method according to claim 1, wherein the machine element is a stator.

15. The method according to claim 14, wherein the machine element is a stator enclosing a rotor.

16. Method according to claim 14, characterized in that the machine element is a stator enclosed by a rotor (8).

17. An electric machine with a machine element with a plurality of magnetic poles distributed around a machine axis (GL) and with at least one coil, comprising several conductors distributed around the machine axis (GL) and each of which is located in a hollow space or in a groove, in which the machine element forms a gap surface enclosing the machine axis (GL), on which (gap surface) the machine element adjoins a further machine element via a machine gap and is made of a plastic, and in which at least in the recesses for the coil sections or conductors, channel sections are formed through which a coolant can circulate, wherein the machine element is manufactured at least on its gap surface from plastic in a molding or casting process, and that the channel sections are created using a filling material, which was inserted or applied before the molding or casting process to keep the channel sections free and was removed after the molding or casting process.

18. The electric machine according to claim 17, wherein the machine element, at least at its area comprising the magnetic poles, is made of a plastic, which contains an electrically insulating, but magnetically conducting filler.

19. An electric machine with a machine element with a plurality of magnetic poles distributed around a machine axis (GL) and with at least one coil, comprising several conductors distributed around the machine axis (GL) and each of which is located in a hollow space or in a groove, and the machine element forms a gap surface enclosing the machine axis (GL), wherein the machine element, at least at its area comprising the magnetic poles, is made of a plastic, which contains an electrically insulating, but magnetically conducting filler.

20. The electric machine according to claim 19, wherein at least in the recesses for the coil sections or conductors, channel sections are formed through which a coolant can circulate.

21. The electric machine according to claim 20, wherein the channel sections are created using a filling material, which was inserted or applied before the casting process to keep the channel sections free and was removed after the molding or casting process.

22. The electric machine according to claim 21, wherein the filling material was removed by heating and or melting.

23. The electric machine according to claim 17, wherein the machine element comprises several open grooves in the direction of the machine gap for the coil sections of the at least one coil, and that a tube-shaped wall made of plastic enclosing the machine element on its surface facing the machine gap is provided with preferably strip-shaped protrusions extending into these grooves and positively anchored there.

24. The electric machine according to claim 17, wherein the recesses have a reduced groove width at their groove opening and an enlarged groove width at a distance form the groove opening.

25. The electric machine according to claim 17, wherein a plate packet comprising the recesses for the at least one coil.

26. The electric machine according to claim 17, wherein the at least one coil comprises coil ends, and that in the area of at least one coil end, at least one cooling medium channel at least partially enclosing said coil end is formed.

27. The electric machine according to claim 17, wherein the sections of the at least one coil are accommodated in coil carriers made of a magnetically neutral material and distributed around the machine axis provided on the gap surface, and the that coil carriers are embedded in the plastic, which contains an electrically insulating, but magnetically conducting filler, thus producing a machine element body made of plastic and forming the plurality of magnetic poles on the gap surface.

28. The electric machine according to claim 27, wherein cooling channels are formed in the coil carriers.

29. The electric machine according to claim 27, wherein a reinforcing metal frame forming functional elements of the machine element is embedded in the plastic.

30. The electric machine according to claim 29, wherein the metal frame is enclosed at least to the greatest extent possible by the plastic.

31. The electric machine according to claim 29, wherein the molding process is conducted so that the at least one coil and a part of the machine element possibly made of a magnetically and electrically conductive material and accommodating the coil, a plate packet, is electrically insulated from the metal frame.

32. The electric machine according to claim 17, wherein the machine element is a stator.

33. The electric machine according to claim 32, wherein the machine element is a stator enclosing a rotor.

34. The electric machine according to claim 32, wherein the machine element is a stator enclosed by a rotor.
